(19) United States
(12) Patent Application Publication
(10) Pub. No.: US 2018/0172860 A1
(43) Pub. Date: Jun. 21, 2018

(54) Time-Lapsed Seismic Wavefield Monitoring of Downhole Formations

(71) Applicant: Halliburton Energy Services, Inc, Houston, TX (US)

(72) Inventors: Glenn A. Wilson, Houston, TX (US); Burkay Donderici, Houston, TX (US)

(21) Appl. No.: 15/556,840

(22) PCT Filed: Aug. 5, 2015
(86) PCT No.: PCT/US2015/043782

§ 371 Date: Sep. 8, 2017

(51) Int. Cl. G01V 1/30; G01V 1/50

(52) U.S. Cl. CPC G01V 1/308; G01V 2210/665; G01V 2210/663; G01V 1/50

(57) ABSTRACT

A time-lapse seismic wavefield monitoring system for a formation includes at least one seismic wavefield source and at least one seismic wavefield sensor to collect seismic wavefield survey data corresponding to the formation in response to an emission from the at least one seismic wavefield source. The seismic wavefield survey data includes first seismic wavefield data collected at a first time and second seismic wavefield data collected at a second time. The time-lapse seismic wavefield monitoring system also includes a processing unit in communication with the at least one seismic wavefield sensor. The processing unit determines time-lapsed seismic wavefield data based on the first seismic wavefield data and the second seismic wavefield data, and performs an analysis of the time-lapsed seismic wavefield data to determine an attribute change in an earth model.

### FIELD OF THE DISCLOSURE

Embodiments of present disclosure generally relate to seismic method-based monitoring and, more particularly, to time-lapsed seismic wavefield monitoring and analysis of formations.

### BACKGROUND

During oil and gas exploration and production, many types of information are collected and analyzed. The information is used to determine the quantity and quality of hydrocarbons in a formation, and to develop or modify strategies for hydrocarbon production. Efforts to improve and more efficiently obtain meaningful information are ongoing.

### BRIEF DESCRIPTION OF THE DRAWINGS

FIGS. 1A-1C show a time-lapsed seismic wavefield scenario, according to certain illustrative embodiments of the present disclosure;

FIG. 2 shows a logging-while-drilling environment in which seismic wavefield survey data may be collected, according to certain illustrative embodiments of the present disclosure;

FIG. 3 shows an illustrative wireline logging environment in which seismic wavefield survey data may be collected, according to certain illustrative embodiments of the present disclosure;

FIG. 4 is a flow chart of a time-lapsed seismic wavefield analysis method, according to certain illustrative methods of the present disclosure; and

FIG. 5 shows an inversion workflow suitable for use with time-lapse seismic wavefield analysis operations, according to certain illustrative methods of the present disclosure.

### DESCRIPTION OF ILLUSTRATIVE EMBODIMENTS

Illustrative embodiments and related methods of the present disclosure are described below as they might be employed in systems and methods for time-lapsed seismic wavefield monitoring and analysis. In the interest of clarity, not all features of an actual implementation or method are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure. Further aspects and advantages of the various embodiments and related methods of the disclosure will become apparent from consideration of the following description and drawings.

As described herein, the present disclosure is directed to methods for time-lapsed seismic wavefield monitoring and analysis of downhole formations. In a generalized embodiment, the system utilizes at least one seismic wavefield source to emit a seismic wavefield into the formation. At least one seismic wavefield sensor is also provided to collect seismic wavefield survey data which corresponds to the response of the formation due to the emitted seismic wavefield, wherein the seismic wavefield survey data includes data collected at a first time and a second time. Processing circuitry communicably coupled to the seismic wavefield sensor determines time-lapsed seismic wavefield data based upon the first and second seismic wavefield survey data. The processing circuitry then analyzes the time-lapsed seismic wavefield data to determine an attribute change in an earth model of the formation. In certain embodiments, the determined attribute change corresponds to or is related to a change in compressibility. This attribute change may be used to update a compressibility model or other models related to an earth model. In certain embodiments, the analysis of the time-lapsed seismic wavefield data is an inversion or imaging (e.g., migration) of the time-lapsed seismic wavefield data.

More specifically, the illustrative embodiments described herein relate to time-lapsed (“4D”) seismic modeling, inversion, and imaging for any type of seismic data acquired from either temporal or permanent seismic data acquisition systems. The disclosed embodiments have specific relevance to, for example, vertical seismic profiling (“VSP”) with distributed acoustic sensing (“DAS”).

Decisions pertaining to reservoir management are made on the basis of earth models which characterize production and subsurface uncertainty using earth models constructed and populated with static data (e.g., reservoir structure, porosity, permeability), quasi-static data (e.g., time-lapse seismic attributes), and dynamic data (e.g., fluid saturation). Formation attributes are typically assigned from the geostatistical population of petrophysical data within structural models interpreted from seismic and well log data. Earth models evolve as further static, quasi-static and dynamic data are acquired, interpreted, and integrated into the model during the life of the field. During reservoir production and/or injection, subsurface uncertainty is decreased as multi-phase flow simulations are history-matched with known fluid volumetrics and other measured data (e.g., pressure, temperature, electromagnetics, gravity, production logs).

Elastic properties of a formation are sensitive to fluid substitution, which is the replacement of one fluid type with another which typically happens during production and well stimulation operations. As described herein, the purpose of time-lapsed seismic data is to generate quasi-static (e.g., time-lapsed seismic attributes) and dynamic (e.g., fluid saturation) data that can be supplemented to earth modeling and reservoir management workflows to minimize subsurface uncertainty, so as to optimize production and/or injection practices and/or to advise of appropriate intervention strategies and practices in advance of unfavorable production scenarios. For example, in certain embodiments, control of intelligent completions in both producing and injection wells is optimized by monitoring changes in fluid saturation during a water or CO₂ flood or cyclical water-CO₂ flood during production.

The elastic properties of a formation are heterogeneous, generally anisotropic and may be frequency-dependent. The rock and fluid properties of a formation include but are not limited to porosity, permeability, and fluid saturation. For a given formation, rock physics-based relations can relate or transform certain elastic properties to certain rock and/or fluid properties, and vice versa.

Time-lapsed seismic wavefields measured in the various time-lapse seismic methods are nonlinear with respect to the changes in the elastic properties of the formation. The relationships between the observed time-lapsed seismic wavefields and the changes in the elastic properties of the formation are described by wave equations augmented with appropriate boundary conditions.

Without loss of generality, the illustrative methods disclosed herein are described in terms of acoustic wavefields and may be generalized to elastic wavefields. It is noted that there are certain trade-offs for treating the earth as a fluid (i.e., no shear waves), but acoustic wavefield modeling has been applicable for 3D modeling of seismic surveys in complex formations. It is important to emphasize the modeling and inversion of this disclosure is nonlinear and can be described as full waveform. While the following describes the wavefields in the frequency-domain, the methods can equally be applied in the time-domain without any loss of generality.

In view of the foregoing, the illustrative embodiments and methods described herein detail the workflows of time-lapsed seismic wavefield modeling, inversion, and imaging that support time-lapse seismic reservoir monitoring, in particular, for a permanent seismic reservoir monitoring system (e.g., DAS) or other surface and/or downhole installation systems. However, the embodiments may also be deployed temporarily using, for example, downhole assemblies (e.g., logging or wireline assemblies), or remote operated vehicle (ROV) (e.g., ocean-bottom nodes). Nevertheless, the illustrative workflows may be used for feasibility modeling to evaluate system sensitivity to geological formations of interest; modeling to support system design considerations, including source and/or receiver configurations and/or system parameters; inversion and/or imaging to support time-lapsed seismic data interpretation; history-matching of multiple time-lapsed seismic data; integration with earth models and digital asset models; or integration with intelligent well completions. These and other advantages of the present disclosure will be apparent to those ordinarily skilled in the art.

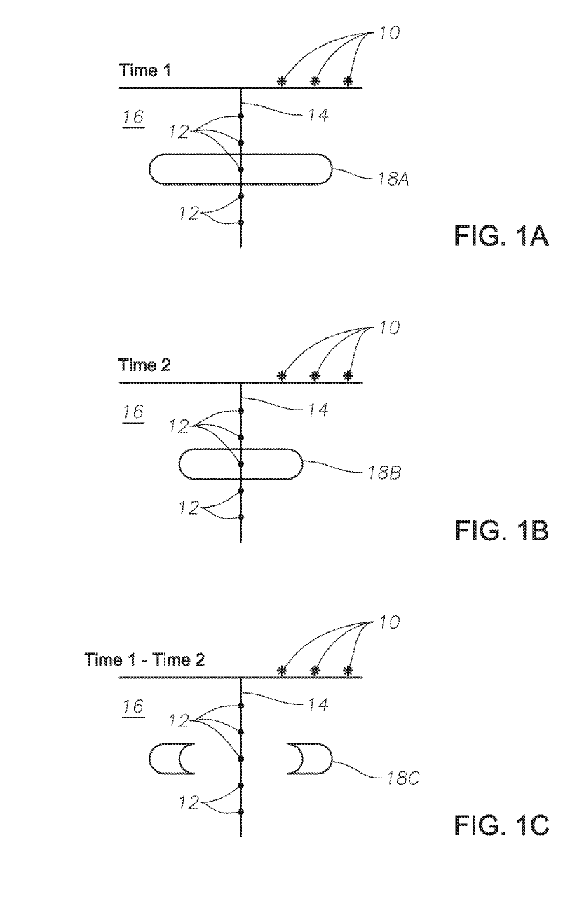

FIGS. 1A-1C show time-lapsed seismic wavefield analysis scenarios, according to certain illustrative methods of the present disclosure. FIG. 1A shows a scenario at Time 1, and shows one or more seismic wavefield source(s) 10 and one or more seismic wavefield sensor(s) or receiver(s) 12 deployed along a monitored wellbore 14. FIG. 1B shows the scenario at Time 2, and FIG. 1C shows the time-lapsed change in the compressibility K(r) due to the fluid substitution within formation 16. To conduct a seismic wavefield survey, seismic wavefield source 10 emits a seismic wavefield into formation 16, and seismic wavefield sensors 12 detect the seismic signal in response to the emitted seismic wavefield. At Time 1, the detected seismic wavefield signal is affected by properties of formation 16 including formation region or volume 18A. The survey is repeated at Time 2, where the detected seismic wavefield signal is affected by properties of formation 16 including volume 18B. Assuming that the position of seismic wavefield source(s) 10 and sensor(s) 12 does not change, at least the movement of fluids in formation 16 may cause the seismic wavefield survey data corresponding to Time 1 and Time 2 to be different, thereby resulting in first seismic wavefield survey data and second seismic wavefield survey data, respectively.

Still referring to FIGS. 1A-1C, in certain methods, the seismic wavefield survey data may also change by varying control parameters or position of seismic wavefield source(s) 10 and/or sensor(s) 12. As long as relevant seismic wavefield survey parameters (e.g., control parameters, position, etc.) are tracked, an estimate of changes in the seismic wavefield survey data that are due to movement of fluids (or other formation attribute changes) may be obtained from time-lapsed seismic wavefield analysis of the seismic wavefield survey data collected at time n and time n+delay (i.e., Time 1 and Time 2, respectively). Such formation attribute changes (i.e., attribute differences between Time 1 and Time 2) are represented by volume 18C. As described herein, the delay value may vary, although it is expected to be in the range where measureable fluid movement has occurred (e.g., more than 1 day and typically on the order of hundreds of days). A more detailed explanation of the illustrative time-lapsed seismic wavefield analysis techniques are provided below.

The scenarios illustrated in FIGS. 1A-1C show seismic wavefield source(s) 10 at a surface location and seismic wavefield sensor(s) 12 deployed along wellbore 14 to conduct seismic wavefield surveys of formation 16. In alternate embodiments, however, both seismic wavefield source(s) 10 and sensor(s) 12 may be deployed along wellbore 14. In either embodiment, however, seismic wavefield source(s) 10 and/or sensor(s) 12 may form part of a downhole assembly such as, for example, a logging-while-drilling (“LWD”) tool, measurement-while-drilling (“MWD”), wireline logging tool, or permanent well installation system (e.g., injection wells, production wells, or monitoring wells).

The positioning of seismic wavefield source(s) 10 and sensor(s) 12 relative to each other and formation 16 determines which formation region most strongly affects the collected seismic wavefield survey data and the related time-lapsed data. As desired, additional seismic wavefield source(s) 10 and/or seismic wavefield sensor(s) 12 may be utilized in alternative embodiments to thereby expand the survey region. Furthermore, the resolution of the seismic wavefield survey data can be adjusted by increasing or decreasing the number of seismic wavefield source(s) 10 and/or sensor(s) 12 utilized. Furthermore, the spacing between seismic wavefield source(s) 10 and/or sensor(s) 12 may vary.

The scenarios of FIGS. 1A-1C are not intended to limit the illustrative embodiments described herein. For example, other applications may include seismic wavefield sources and/or sensors located at the earth's surface, at the seafloor, in a single borehole, and/or in multiple boreholes. Furthermore, in yet other embodiments, seismic wavefield survey data may additionally or alternatively be collected using ambient seismic wavefield phenomena in the downhole environment (i.e., a controlled seismic wavefield source is not necessary).

The seismic wavefield source(s) and/or sensor(s) used to collect seismic wavefield survey data may be temporarily or permanently positioned downhole. Temporary positioning seismic wavefield sources and/or seismic wavefield field sensors in a downhole environment may involve, for example, LWD operations or wireline logging operations with one or more seismic wavefield sources and/or seismic wavefield sensors. Meanwhile, permanent positioning of seismic wavefield source(s) and/or seismic wavefield sensor(s) in a downhole environment may involve, for example, permanent well installations with one or more seismic wavefield source(s) and/or seismic wavefield sensor(s).

While collecting seismic wavefield survey data using the same seismic wavefield source and seismic wavefield sensor positions facilitates time-lapsed seismic wavefield analysis, it should be noted that seismic wavefield survey data collected at different times may include seismic wavefield data where the seismic wavefield source position and/or the seismic wavefield sensor position has changed. In such case, collected position information for the seismic wavefield source and/or the seismic wavefield sensors can be used to determine time-lapsed seismic wavefield data as described herein.

The collection of seismic wavefield survey data and the illustrative disclosed time-lapsed seismic wavefield analysis techniques can be best appreciated in suitable application contexts such as an LWD environment, a wireline logging environment, and/or permanent well installations, as described below.

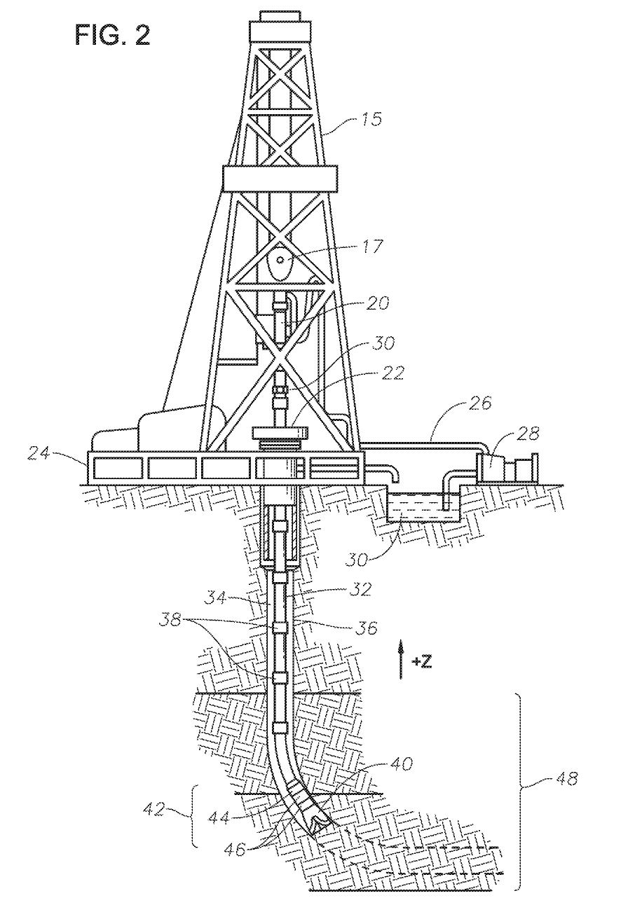

FIG. 2 shows a drilling environment in which the present disclosure may applied, according to certain illustrative embodiments of the present disclosure. The drilling environment includes a drilling platform 24 that supports a derrick 15 having a traveling block 17 for raising and lowering a drill string 32. A drill string kelly 20 supports the rest of drill string 32 as it is lowered through a rotary table 22. Rotary table 22 rotates drill string 32, thereby turning drill bit 40. As bit 40 rotates, it creates a borehole 36 that passes through various formations 48. A pump 28 circulates drilling fluid through a feed pipe 26 to kelly 20, downhole through the interior of drill string 32, through orifices in drill bit 40, back to the surface via annulus 34 around drill string 32, and into a retention pit 30. The drilling fluid transports cuttings from borehole 36 into pit 30 and aids in maintaining the integrity of borehole 36. Various materials can be used for drilling fluid, including oil-based fluids and water-based fluids.

As shown, logging tools 46 may be integrated into bottom-hole assembly 42 near drill bit 40. As drill bit 40 extends the borehole 36 through formation 48, logging tools 46 may collect measurements relating to various formation properties, as well as the tool orientation and various other drilling conditions. Each of logging tools 46 may take the form of a drill collar, i.e., a thick-walled tubular that provides weight and rigidity to aid the drilling process. For the present discussion, logging tools 46 include seismic wavefield sensors and/or seismic wavefield sources. Logging tools 46 may also include position sensors to collect position information related to seismic wavefield survey data. In alternative embodiments, seismic wavefield sources, seismic wavefield sensors, and/or position sensors may be distributed along drill string 32. For example, seismic wavefield sources, seismic wavefield field sensors, and/or position sensor may be attached to or integrated with adapters 38 that join sections of drill string 32 together. In such embodiments, electrical wires and/or optical fibers may extend through an interior of the drill string 32, through sections of the drill string 32, and/or in/through the adaptors 38 to enable collection of seismic wavefield survey data and/or position data.

In some embodiments, measurements from the seismic wavefield sensors and/or position sensors are transferred to the surface using known telemetry technologies or communication links. Such telemetry technologies and communication links may be integrated with logging tools 46 and/or other sections of drill string 32. As an example, mud pulse telemetry is one common technique for providing a communications link for transferring logging measurements to a surface receiver 30 and for receiving commands from the surface, but other telemetry techniques can also be used. In some embodiments, bottom-hole assembly 42 includes a telemetry sub 44 to transfer measurement data to the surface receiver 30 and to receive commands from the surface. In alternative embodiments, telemetry sub 44 does not communicate with the surface, but rather stores logging data for later retrieval at the surface when the logging assembly is recovered.

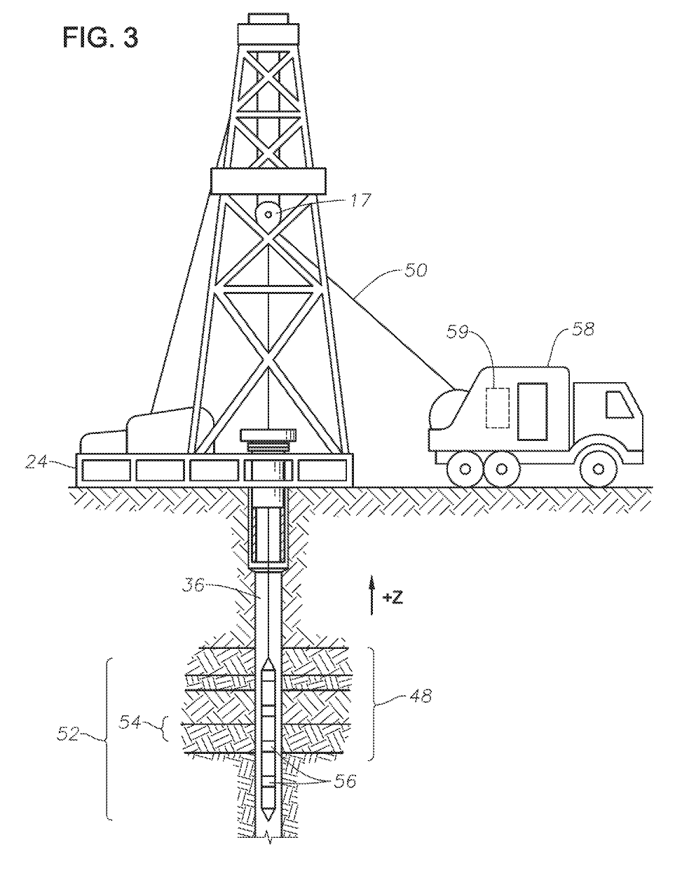

At various times during the drilling process, or after the drilling has been completed, drill string 32 shown in FIG. 2 may be removed from borehole 36. Once drill string 32 has been removed, as shown in FIG. 3, a wireline tool string 52 can be lowered into borehole 36 by a cable 50. In some embodiments, cable 50 includes conductors and/or optical fibers for transporting power to wireline tool string 52 and data/communications from wireline tool string 52 to the surface. It should be noted that various types of formation property sensors can be included with wireline tool string 52. In accordance with the disclosed time-lapse seismic wavefield analysis techniques, the illustrative wireline tool string 52 includes logging sonde 54 with acoustic sources, acoustic field sensors, and/or position sensors. Logging sonde 54 may be attached to other tools of the wireline tool string 52 by adaptors 56.

In FIG. 3, a wireline logging facility 58 receives measurements from the seismic wavefield sensors, position sensors, and/or or other instruments of wireline tool string 52 collected as wireline tool string 52 passes through formations 48. In some embodiments, wireline logging facility 58 includes computing facilities 59 for managing logging operations, for acquiring and storing measurements gathered by logging sonde 54, for inverting measurements to determine formation properties, and/or for displaying measurements or formation properties to an operator. In some embodiments, wireline tool string 52 may be lowered into an open section of borehole 36 or a cased section of the borehole 36.

In addition to the drilling and wireline applications, illustrative embodiments of the present disclosure may also be deployed along a permanent well installation, as previously discussed. Regardless of the application selected, the seismic wavefield source(s) and sensor(s) are coupled to processing circuitry (i.e., computer) that acts as a data acquisition and/or processing system to analyze the seismic wavefield measurements and perform the time-lapsed techniques described herein. For example, processing circuitry (e.g., computer 59) may process seismic wavefield survey data, including first seismic wavefield survey data collected at a first time and second seismic wavefield survey data collected at a second time, to determine time-lapsed seismic wavefield data. In certain illustrative methods, the processing circuitry may perform an inversion of the time-lapsed seismic wavefield data to determine an attribute change in an earth model. Furthermore, the processing circuitry or another control system may direct control options for seismic wavefield sources. Such control options may include waveform options, current level options, and timing synchronization between seismic wavefield sources and seismic wavefield sensors.

Although not shown, the processing circuitry may include at least one processor, a non-transitory, computer-readable storage (also referred to herein as a “computer-program product”), transceiver/network communication module, optional I/O devices, and an optional display (e.g., user interface), all interconnected via a system bus. In one embodiment, the network communication module is a network interface card (“NIC”) and communicates using the Ethernet protocol. In other embodiment, the network communication module 205 may be another type of communication interface such as a fiber optic interface and may communicate using a number of different communication protocols. Software instructions executable by the processor for implementing software instructions in accordance with the illustrative methods described herein, may be stored in storage or some other computer-readable medium.

The processing circuitry may be connected to one or more public (e.g., the Internet) and/or private networks via one or more appropriate network connections. It will also be recognized that the software instructions may also be loaded into storage from a CD-ROM or other appropriate storage media via wired or wireless methods.

Moreover, those ordinarily skilled in the art will appreciate that embodiments of the disclosure may be practiced with a variety of computer-system configurations, including hand-held devices, multiprocessor systems, microprocessor-based or programmable-consumer electronics, minicomputers, mainframe computers, and the like. Any number of computer-systems and computer networks are acceptable for use with the present disclosure. Embodiments of the disclosure may be practiced in distributed-computing environments where tasks are performed by remote-processing devices that are linked through a communications network. In a distributed-computing environment, program modules may be located in both local and remote computer-storage media including memory storage devices. The present disclosure may therefore, be implemented in connection with various hardware, software or a combination thereof in a computer system or other processing system. Subject to network reliability, the time-lapsed seismic wavefield analysis techniques described herein may be performed in real-time to update production, enhance oil recovery (“EOR”) operations, and/or other operations.

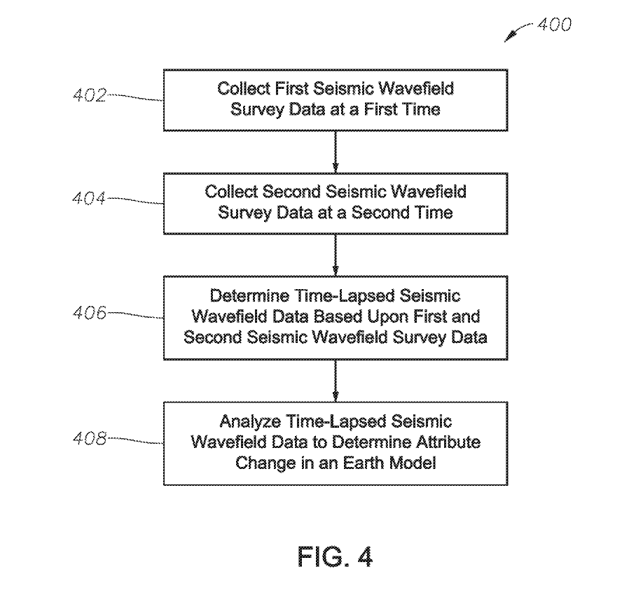

FIG. 4 is a flow chart of a time-lapsed seismic wavefield analysis method 400, according to certain illustrative methods of the present disclosure. Method 400 may be performed, for example, by one or more computers (e.g., computer 59 of FIG. 3) in communication with seismic wavefield sources and/or seismic wavefield sensors. At block 402, method 400 collects first seismic wavefield survey data at a first time. At block 404, second seismic wavefield survey data is collected at a second time. At block 406, time-lapsed seismic wavefield data is determined based on the first seismic wavefield data and the second seismic wavefield data. In certain methods, the time-lapsed seismic wavefield data may be determined by defining a relationship between the first seismic wavefield data and the second seismic wavefield data. For example, the relationship may be a perturbation scalar value that defines a relationship between the first seismic wavefield data and the second seismic wavefield data.

At block 408, the time-lapsed seismic wavefield data is analyzed to determine an attribute change in an earth model. In certain methods, the analysis step of block 408 may include comparing the observed time-lapsed seismic wavefield data with simulated time-lapsed seismic wavefield data. Furthermore, the analysis of block 408 may include relating the time-lapsed seismic wavefield data to change in compressibility. In certain other illustrative methods, the analysis of block 408 may subject attribute changes of an earth model to one or more rock physics constraints and/or to history-matched constraints. In yet other methods, the analysis of block 408 may include performing a full waveform (i.e., inclusive of all physics of time-lapsed seismic wavefield analysis) time-lapse inversion of the time-lapsed seismic wavefield data in order to determine the attribute change. In other methods, the analysis of block 408 may apply a sensitivity-based analysis to determine the attribute change. Moreover, in yet other methods, the time-lapsed seismic wavefield data may be imaged or inverted, used to update an earth model, and/or used to perform a downhole operation.

As defined herein, modeling refers to taking a model, simulating it, and predicting data. Imaging is where data is directly manipulated to construct a model, without any modeling. Inversion is where one begins with a model, predicts data, compares that data to measured data, and tweaks the model until the measured and predicted data match.

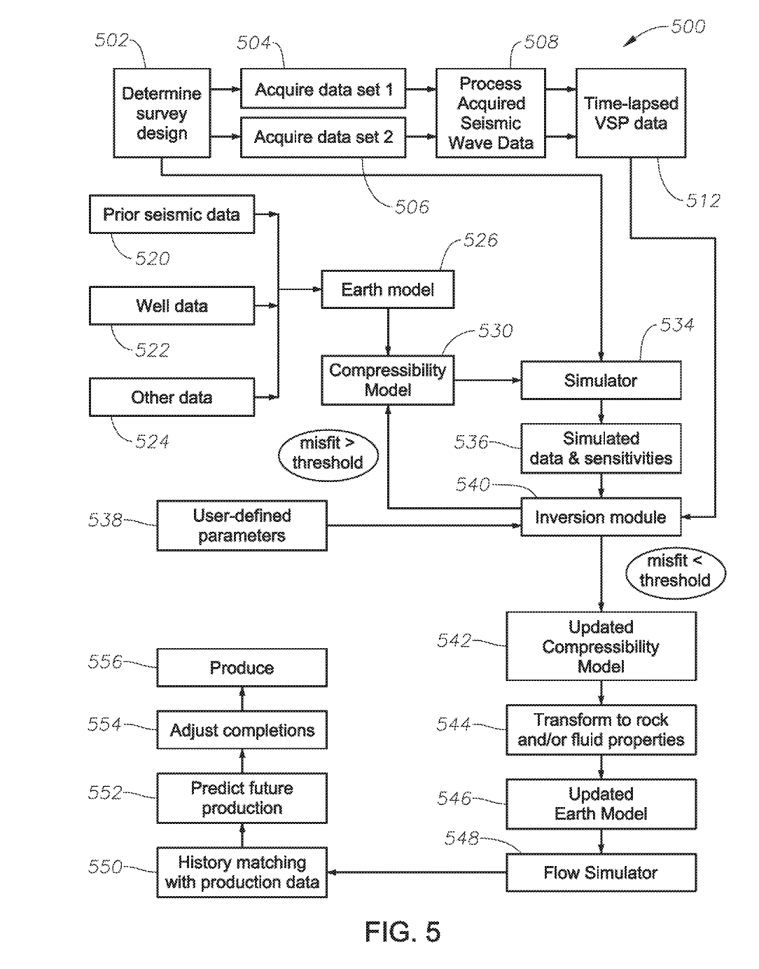

FIG. 5 shows an inversion workflow 500 suitable for use with time-lapse seismic wavefield analysis operations, according to certain illustrative methods of the present disclosure. In this example, workflow 500 is applied using a VSP DAS system for reservoir monitoring and integration with intelligent completions. In workflow 500, the seismic wavefield survey design is determined at block 502. For example, the seismic wavefield survey design may include position, spacing, and control parameters for seismic wavefield source(s) and seismic wavefield sensor(s). At block 504, a first set of seismic wavefield data is collected. At a later time, a second set of seismic wavefield data is collected at block 506. The first and second sets of seismic wavefield data are processed at block 508 to obtain time-lapsed seismic wavefield data 512. The time-lapsed seismic wavefield data 512 is provided to inversion block 540.

Inversion block 540 also receives simulated time-lapsed seismic wavefield data 536 and user-defined parameters 538 as input. Examples of parameters 538 may include adaptation step sizes, constraints on model values, and criteria for terminating the inversion processes. The simulated time-lapsed seismic wavefield data 536 is determined by a simulator 534 that receives the seismic wavefield survey design 502 and a compressibility model 530 as input. In certain illustrative methods, simulator 534 may provide sensitivity information to inversion block 540. Compressibility model 530 is initially derived from a transformation of an earth model 526, which in tum is obtained using seismic data 520, well data 522, and/or other data 524.

In at least some embodiments, inversion block 540 compares the simulated time-lapsed seismic wavefield data 536 with the measured time-lapsed seismic wavefield data 512. If the misfit (error) between the simulated time-lapsed seismic wavefield data 536 and the time-lapsed seismic wavefield data 512 is greater than a threshold, the compressibility model 530 is updated, the seismic wavefield measurement simulation is repeated at block 534, and the simulated time-lapsed seismic wavefield data is re-determined. An iterative process of comparing simulated time-lapsed seismic wavefield data 536 with the time-lapsed seismic wavefield data 512, updating the compressibility model 530, and re-simulating continues until the misfit between the simulated time-lapsed seismic wavefield data 536 and the time-lapsed seismic wavefield data 512 is less than or equal to the threshold. The result of this iterative process is an updated compressibility model 542 that conforms to the time-lapsed seismic wavefield data 512 to within a threshold tolerance.

At block 544, compressibility values of the updated compressibility model 542 are transformed to rock and/or fluid properties to obtain an updated earth model 546. The updated earth model 546 is used, for example, by a flow simulator 548 to predict future production 552. In certain methods, the output of the flow simulator 548 is compared with production data by history matching at block 550 to predict future production 552. Production control parameters are adjusted accordingly at block 554 to update production, and production is conducted at block 556.

Thus, the illustrative workflow 500 represents an improved method of time-lapsed seismic wavefield analysis and shows how it may be used to update production control parameters. A more detailed discussion incorporating specific time-lapsed seismic wavefield analysis modeling concepts will now be provided.

Generally, the distribution of the elastic properties in an earth model of the formation can be assumed to be piecewise continuous. For example, a three-dimensional (“3D”) earth model can be constructed as the juxtaposition of volume elements populated by discrete values of the elastic properties and the seismic wavefields and/or sensitivities modeled using a 3D numerical simulator. Assuming exp(−iωt) time dependence, the frequency-domain acoustic approximations for a medium with a uniform background density ρ_{b}, the vector particle velocity v and the pressure p fields satisfy the coupled equations:

∇p(r)−iωρ_{b}v(r)=f(r), Eq.(1)

∇·v(r)−iωκ(r)p(r)=q(r), Eq.(2)

where f(r) is a dipole source term, q(r) is a monopole source term; and κ(r) is the compressibility, assumed to be complex and frequency-dependent to account for an attenuation function Q(r).

Re-arranging Equation (1), substituting into Equation (2), and noting that ∇·∇p(r)=∇²p(r), we obtain the scalar wave equation for the pressure field:

∇²p(r)+ω²ρ_{b}κ(r)p(r)=iωρ_{b}q(r)−∇·f(r), Eq.(3).

It is noted that wavefield modeling is typically performed on a variant of Equation (3) using finite-difference methods. Equation (3) may also be Fourier transformed, such that wavefield modeling is performed in the spatial frequency domain.

The compressibility can be separated into background (b) and anomalous (a) parts:

κ(r)=κ_{b}(r)+κₐ(r), Eq.(4)

such that Equation (3) can be separated into equations for the background p_{b} and anomalous pₐ pressure fields:

∇²p_{b}(r)+ω²ρ_{b}κ_{b}(r)p_{b}(r)=iωρ_{b}q(r)−∇·f(r), Eq.(5)

∇²pₐ(r)+ω²ρ_{b}κ(r)pₐ(r)=−ω²ρ_{b}κₐ(r)p_{b}(r), Eq.(6)

where:

p(r)=p_{b}(r)+pₐ(r). Eq.(7).

The background model is chosen such that an analytical or semi-analytical solutions to Equation (5) can be derived, e.g., for a uniform wholespace or layered wholespace. It follows that the scalar Green's function be introduced for the background material:

∇²G_{b}(r′,r)+ω²ρ_{b}κ_{b}(r)G_{b}(r′,r)=−δ(r′,r), Eq.(8)

Equation (6) is multiplied by G_{b}, and Equation (8) by pₐ, subtract, and integrate over all space to obtain the scalar Fredholm integral equation of the first kind:

pₐ(r′)=ω²ρ_{b}∫_{V}G_{b}(r′,r)κₐ(r)[p_{b}(r)+pₐ(r)]d³r. Eq.(9).

Equation (9) is discretized as the matrix equation:

pₐ=ω²ρ_{b}G_{b}κₐ[p_{b}+pₐ], Eq.(10),

for r′∈V where pₐ and p_{b} are vectors of the anomalous and background pressure fields, G_{b} is a matrix of the volume integrated Green's functions, and κₐ is a diagonal matrix of the anomalous compressibilities. Equation (10) can be re-arranged and solved as either:

pₐ=ω²ρ_{b}[I−ω²ρ_{b}G_{b}κₐ]⁻¹G_{b}κₐp_{b}, Eq.(11)

or:

p=[I−ω²ρ_{b}G_{b}κₐ]⁻¹p_{b}, Eq.(12),

where Equation (12) solves directly for the total pressure rather than the anomalous pressure. Equation (12) is particularly advantageous as it directly avoids the propagation of numerical round off errors associated with subsequent evaluations of Equation (9).

Equation (12) can be solved using iterative or direct methods. A variety of numerical and computational optimizations can be achieved by appropriate discretization of the model domain, exploiting the structure of the Green's functions and/or conditioning Equation (12) with contraction operators.

A similar integral equation formulation can be constructed for the elastic wave equation, in terms of a displacement vector u and slowness s. The slowness is separated into background and anomalous parts, such that the displacement vector can be expressed as the superposition of background and anomalous parts. A Green's function for the background model is introduced, and a vector Fredholm integral equation of the first kind is obtained. This derivation is straightforward, though is not included in this disclosure.

### Time-Lapsed Acoustic Wavefield Modeling.

For illustrative seismic wavefield surveys consisting of identical transmitter and receiver locations conducted at two different times (FIGS. 1A-1C; e.g., pre-production, and during production; or both during production), denoted by superscripts 1 and 2, we can write forms of Equation (7) as:

p¹(r′)=p_{b}(r′)+ω²ρ_{b}∫_{V}G_{b}(r′,r)κₐ¹(r)[p_{b}(r)+pₐ¹(r)]d³r. Eq.(13).

p²(r′)=p_{b}(r′)+ω²ρ_{b}∫_{V}G_{b}(r′,r)κₐ²(r)[p_{b}(r)+pₐ²(r)]d³r. Eq.(14).

Note that the background model and background pressure fields are constant between the two surveys, and the time-lapse change in compressibility manifests only in the change of the anomalous compressibility from κ_â2 (r) to κ_â1 (r).

The time-lapse seismic response is defined as the difference between Equations (13) and (14):

p¹(r′)−p²(r′)=ω²ρ_{b}∫_{V}G_{b}(r′,r){κₐ¹(r)[p_{b}(r)+pₐ¹(r)]−κₐ²(r)[p_{b}(r)+pₐ²(r)]}d³r. Eq.(15).

Time lapse seismic data can be measured as the difference in pressure field data between the two seismic wavefield surveys measured at different moments in time for the same source and receiver locations. This manifests as the difference in the anomalous pressures fields between the two seismic surveys.

The difficulty with Equation (15) is that it is nonlinear with respect to both the anomalous compressibility and the pressure fields inside the 3D earth model at both time periods. Given this nonlinearity, it is typical that the time lapse seismic inverse problem is sequentially solved as individual seismic wavefield inversion problems corresponding to each of the independent seismic surveys.

However, in the embodiments of this disclosure, we demonstrate that there exists a relation between the anomalous pressure fields at the two time periods:

p²(r′)=λ(r′)p¹(r′), Eq.(16),

where λ(r′) is called a perturbation scalar. Equation (16) is general in that it's not necessary to enforce specific values, relations or functions upon the perturbation scalar.

Without loss of generality, it follows that Equation (16) reduces Equation (13) to the integral equation:

[1−λ(r′)]p¹(r′)=ω²ρ_{b}∫_{V}G_{b}(r′,r){κₐ¹(r)−κₐ²(r)}{p_{b}(r)+[1−λ(r′)]p¹(r′)}d³r. Eq.(17)

If it is denoted:

P(r)=[1−λ(r)]p¹(r), Eq.(18).

Δκₐ(r)=κₐ¹(r)−κₐ²(r), Eq.(19).

as the perturbed pressure fields and change in compressibility, respectively, we can re-write Equation (17) as:

P(r′)=ω²ρ_{b}∫_{V}G_{b}(r′,r)Δκₐ(r){p_{b}(r)+P(r)}d³r, Eq.(20)

which is recognized as a Fredholm integral equation of the second kind. Note that the integral in Equation (20) will only have contributions from those volumes of the 3D earth model where Δκₐ(r)≠0. It is understood that in a reservoir, Δκₐ(r)≠0 where oil and/or gas has been displaced by water, gas, or CO2 injection. Moreover, this implies that the modeling and/or inversion domain needs only be limited to the volume where Δκₐ(r)≠0. Thus, Equation (17) can be expanded as:

[1−λ(r′)]p¹(r′)=ω²ρ_{b}∫_{V}G_{b}(r′,r)Δκₐ(r)p_{b}(r)d³r+ω²ρ_{b}∫_{V}G_{b}(r′,r)Δκₐ(r)[1−λ(r)]p¹(r)d³r Eq.(21).

As per electromagnetic modeling, the Green's function G_{b}(r′, r) exhibits a singularity when r′=r which must be avoided when computing the volume integrals in Equation (21). The result is that the dominant contributions to the integrals on the right hand side of Equation (21) are from the observation points r that are proximal to point r′.

If it is assumed that λ(r) is a slowly varying function in the volume V, then:

[1−λ(r′)]p¹(r′)≈ω²ρ_{b}∫_{V}G_{b}(r′,r)Δκₐ(r)p_{b}(r)d³r+ω²ρ_{b}[1−λ(r)]∫_{V}G_{b}(r′,r)Δκₐ(r)p¹(r)d³r Eq.(22).

It is then written:

P_{B}(r′)=ω²ρ_{b}∫_{V}G_{b}(r′,r)Δκₐ(r)p_{b}(r)d³r, Eq.(23).

P_{A}(r′)=ω²ρ_{b}∫_{V}G_{b}(r′,r)Δκₐ(r)p¹(r)d³r, Eq.(24).

and note that p_{B}(r)≠0 and p_{A}(r)≠0 provided that Δκₐ(r)≠0 for all r. Equation (22) can now be rewritten as:

[1−λ(r′)]p¹(r′)=P_{B}(r′)+[1−λ(r′)]P_{A}(r′), Eq.(25)

and re-arranged to obtain:

$$λ ( {r}^{′} ) = \frac{{p}^{1} ( {r}^{′} ) - {P}_{A} ( {r}^{′} ) - {P}_{B} ( {r}^{′} )}{[ {p}^{1} ( {r}^{′} ) - {P}_{A} ( {r}^{′} ) ]} . \qquad Eq . ( 26 ) .$$

which exists provided that Δκₐ (r)≠0.

### Time-Lapse Acoustic Wavefield Sensitivities.

For inversion, we are required to calculate the Frechet derivatives (or sensitivities) of Equation (17) with respect to the time lapse change in compressibility, Δκₐ (r):

$$\frac{\partial p ( {r}^{′} )}{\partial [ {Δκ}_{a} ( r ) ]} = \frac{\partial }{\partial [ {Δκ}_{a} ( r ) ]} {ω}^{2} {ρ}_{b} {\int }_{V} {G}_{b} ( {r}^{′} , r ) {Δκ}_{a} ( r ) \{ {p}_{b} ( r ) + [ 1 - λ ( {r}^{′} ) ] {p}^{1} ( {r}^{′} ) \} {d}^{3} r , \qquad Eq . ( 27 ) .$$

It is noted that:

$$\frac{\partial {G}_{b} ( {r}^{′} , r )}{\partial [ {Δκ}_{a} ( r ) ]} = \frac{\partial {p}_{b} ( r )}{\partial [ {Δκ}_{a} ( r ) ]} = \frac{\partial {p}^{1} ( r )}{\partial [ {Δκ}_{a} ( r ) ]} = 0 ,$$

which implies Equation (28) reduces to:

$$\frac{\partial p ( {r}^{′} )}{\partial [ {Δκ}_{a} ( r ) ]} = {ω}^{2} {ρ}_{b} {\int }_{V} {G}_{b} ( {r}^{′} , r ) \{ {p}_{b} ( r ) + [ 1 - λ ( {r}^{′} ) ] {p}^{1} ( {r}^{′} ) \} {d}^{3} r - {\int }_{V} {G}_{b} ( {r}^{′} , r ) Δ {κ}_{a} ( r ) \frac{\partial λ ( r )}{\partial [ {Δκ}_{a} ( r ) ]} {p}^{1} ( r ) {d}^{3} r \qquad Eq . ( 29 ) .$$

It can then be rewritten that:

F_{QB}¹(r′)=ω²ρ_{b}∫_{V}G_{b}(r′,r){p_{b}(r)+p¹(r′)}d³r, Eq.(30)

as the Quasi-Born sensitivities, and simplify Equation (29) as:

$$\frac{\partial p ( {r}^{′} )}{\partial [ {Δκ}_{a} ( r ) ]} = {F}_{QB}^{1} ( {r}^{′} ) - {\int }_{V}^{ } {G}_{b} ( {r}^{′} , r ) \{ λ ( r ) + {Δκ}_{a} ( r ) \frac{\partial λ ( r )}{\partial [ {Δκ}_{a} ( r ) ]} \} {p}^{1} ( r ) {d}^{3} r . \qquad Eq . ( 31 ) .$$

The advantage of an equation such as Equation (31) is that the Frechet derivatives (or sensitivities) can be evaluated with minimal computational expense since all variables in Equation (31) are known or can be evaluated from chain rule differentiation of Equation (27). Moreover, the above formation can be extended to elastic (vector) wavefields for slowness (or velocity) models.

### Time-Lapse Acoustic Wavefield Inversion.

Time-lapse acoustic wavefield data can be directly modeled and inverted using Equations (17) and (31). This inversion is inclusive of all physics of time-lapsed seismic wavefield analysis, and thus can be categorized as a “full waveform time-lapsed inversion.” Equations (17) and (31) assume that the pressure field inside the volume V from one of the seismic surveys has been inverted a priori.

The change in compressibility can be a frequency-dependent and complex quantity, from which the frequency-dependent attenuation factor may be retrieved. The choice of an inversion algorithm and related regularization to implement the inversion is arbitrary, and may be deterministic and/or stochastic.

### Rock Physics Constraints.

Through rock physics relations (e.g., Gassmann's relations), the change in compressibility Δκ can be related to various changes in fluid bulk modulus ΔK_{f} via an analytical function:

Δκₐ(r)=f[ΔK_{f}(r)], Eq.(32)

such that we can calculate the sensitivities in Equation (31) with respect to the time-lapsed change fluid bulk modulus:

$$\frac{\partial }{\partial [ Δ {K}_{f} ( r ) ]} = \frac{\partial [ Δ κ ( r ) ]}{\partial [ Δ {K}_{f} ( r ) ]} \frac{\partial }{\partial [ Δκ ( r ) ]} . \qquad Eq . ( 33 ) .$$

This enables the inversion method to directly invert for time lapse changes in the fluid bulk modulus.

### Other Considerations.

In the illustrative methods described herein, the methods can be applied to acoustic and/or elastic wavefields. In other, the methods can be applied to the simultaneous modeling, inversion, and/or imaging of time-lapsed seismic wavefield data acquired during at least two different times. In yet other methods, changes in the fluid properties of a model can be constrained to satisfy the mass-balance of the reservoir; i.e., the earth model is constrained by and history-matched production volumetrics.

In certain other embodiments, workflows encapsulating the disclosed methods can be inclusive of any variety of modeling, inversion, and/or imaging methods of seismic data measured at the at least two different times. Such workflows can ensure data quality control (“QC”), system calibration, and may eliminate cumulative errors since any systematic error in the time-lapsed seismic wavefield measurements will result in increasing absolute errors in the time-lapse seismic data.

In yet other illustrative embodiments, the repeated temporal and/or permanent emplacement of the sources and/or receivers in the seismic survey is arbitrary, and they may be placed on the surface, on the seafloor, or in at least one borehole. In other embodiments, the type of seismic source used in the seismic survey is arbitrary, and may include dipole or monopole types. In yet other embodiments, the type of geophone used in the seismic survey is arbitrary, and may include any geophone types (e.g., 3C, 4C, optical fiber cable).

In other embodiments, earth models can be constructed using industry-standard earth modeling software (e.g., Halliburton Energy Services, Co.'s DecisionSpace®) and workflows from available well, seismic, gravity, magnetic, electromagnetic, and production data. The seismic properties of the earth model may include (but not be limited to) compressibility, slowness, and density. Slowness (or velocity) may be anisotropic. Rock and fluid attributes of the earth models can include porosity, permeability, oil saturation, gas saturation, and water saturation.

In yet other embodiments, the elastic attributes of the earth model are populated from the interpolation and/or extrapolation of well-based acoustic data within well-tied seismic-based structural models. In these embodiments, the interpolation and/or extrapolation algorithms may be based on geostatistical methods. Also in these embodiments, the well-based acoustic data can be derived from any one or combination of LWD acoustic data and/or open or cased-hole single or multi-component wireline acoustic data and/or open or cased-hole wireline acoustic data.

In some embodiments, different attributes of the earth model may be assigned to different grids and/or meshes as required for different simulators. For example, the wavefield simulator will generally operate upon a different grid and/or mesh to a multi-phase flow simulator. In these embodiments, the attributes of one grid and/or mesh can be upscaled and/or down-scaled and/or interpolated and/or extrapolated to populate the attributes of another grid and/or mesh. Attribute transforms can be applied before or after such interpolations and/or extrapolations.

The illustrative earth modeling workflows described in this disclosure can be implemented as either stand-alone software or integrated as part of a commercial earth modeling software (e.g., Halliburton Energy Services, Co.'s DecisionSpace®) through an application programmable interface (API). The dimensionality of the earth model and related wavefield simulator (e.g., 1D, 2D, 3D) is based on the interpreter's prejudice and/or requirement for solving particular reservoir monitoring problems. In some embodiments, an earth model of a lower dimensionality (e.g., 1D or 2D) can be extracted from an earth model of a higher dimensionality (e.g., 3D).

The illustrative wavefield simulator can be based on any combination of analytical and/or semi-analytical and/or finite-difference and/or finite-volume and/or finite-element and/or boundary-element and/or integral equation methods implemented in Cartesian and/or cylindrical and/or polar coordinates. The wavefield simulator can be programmed on serial and/or parallel processing architectures.

In certain illustrative embodiments, the seismic wavefield modeling, inversion, and/or imaging algorithms are encapsulated in software which may be programmed on serial and/or parallel processing architectures. The processing of the wavefield modeling, inversion, and/or imaging, and related functions may be performed remotely from the reservoir (e.g., cloud computers), whereby computers at the reservoir site are connected to the remote processing computers via a network. This means that the computers at the reservoir site don't require high computational performance, and subject to network reliability, all wavefield modeling, inversion, and/or imaging can effectively be done in real time.

The illustrative methods disclosed can be incorporated in methods of joint inversion of time-lapse seismic wavefield data with any other geophysical data, electromagnetic (e.g., deep reading resistivity), time-lapse electromagnetic (e.g., permanently deployed fiber optic EM systems), gravity, or time-lapse gravity. The methods disclosed can also be incorporated in methods of joint inversion of time-lapse seismic data with production data, e.g., history-matched multi-phase flow and volumetric data, pressure, temperature (e.g., distributed temperature sensing). The methods disclosed can further be incorporated in a method of joint inversion of time-lapse seismic wavefield data with both other geophysical and production data, described above. The methods disclosed can also be incorporated in reservoir management systems, inclusive of intelligent completions and/or intelligent wells, for improved production enhancement.

In some embodiments, completions may be regulated (or generally controlled) from fluid flow predictions of history-matched reservoir and flow simulations. These simulations may be performed stochastically or deterministically to determine optimal completion regulations (or controls). These simulations may also be used to quantify uncertainties in simulator input parameters (e.g., rock and/or fluid properties and/or distributions).

In those seismic methods whereby seismic wavefield data are acquired from at least two temporal surveys but not acquired at exactly the same source and/or receiver positions required for computing the time-lapsed seismic wavefield data (e.g., cross-borehole seismic, marine seismic), methods of interpolation, extrapolation, and/or integral transforms can be applied to redatum measured seismic data from at least one temporal survey to the same source and/or receiver positions of at least one other temporal survey such that time-lapse seismic data between the at least two temporal seismic surveys can be computed.

Embodiments described herein further relate to any one or more of the following paragraphs:

1. A method for monitoring a downhole formation using a time-lapsed seismic wavefield analysis, the method comprising emitting a seismic wavefield into a formation; at a first time, collecting first seismic wavefield survey data of the formation in response to the emitted seismic wavefield; at a second time, collecting second seismic wavefield survey data of the formation in response to the emitted seismic wavefield; determining time-lapsed seismic wavefield data based upon the first and second seismic wavefield survey data; and analyzing the time-lapsed seismic wavefield data to determine an attribute change of an earth model.

2. A method as defined in paragraph 1, wherein determining the time-lapsed seismic wavefield data comprises defining a relationship between the first and second seismic wavefield survey data.

3. A method as defined in paragraphs 1 or 2, wherein the relationship is defined using a perturbation scalar.

4. A method as defined in any of paragraphs 1-3, wherein analyzing the time-lapsed seismic wavefield data comprises performing an inversion comprising: comparing the time-lapsed seismic wavefield data with simulated time-lapsed wavefield data; and minimizing an error between the time-lapsed seismic wavefield data and the simulated time-lapsed seismic wavefield data subject to constraints imposed on an earth model.

5. A method as defined in any of paragraphs 1-4, wherein analyzing the time-lapsed seismic wavefield data comprises performing an inversion comprising relating the time-lapsed seismic wavefield data to a change in compressibility; and applying a sensitivity-based analysis to determine the attribute change.

6. A method as defined in any of paragraphs 1-5, wherein analyzing the time-lapsed seismic wavefield data comprises relating the time-lapsed seismic wavefield data to a change in compressibility.

7. A method as defined in any of paragraphs 1-6, wherein analyzing the time-lapsed seismic wavefield data comprises subjecting the attribute change to one or more rock physics constraints.

8. A method as defined in any of paragraphs 1-7, wherein analyzing the time-lapsed seismic wavefield data comprises subjecting the attribute change to a sensitivity-based analysis.

9. A method as defined in any of paragraphs 1-7, wherein analyzing the time-lapsed seismic wavefield data comprises subjecting the attribute change to history-match constraints.

10. A method as defined in any of paragraphs 1-9, further comprising imaging the time-lapsed seismic wavefield data.

11. A method as defined in any of paragraphs 1-10, further comprising updating the earth model based upon the attribute change.

12. A method as defined in any of paragraphs 1-11, further comprising performing a downhole operation using the earth model.

13. A system for monitoring a downhole formation using time-lapse seismic wavefield analysis, the system comprising a seismic wavefield source; a seismic wavefield sensor to collect seismic wavefield survey data of the formation in response to an emission from the seismic wavefield source, wherein the seismic wavefield survey data comprises first seismic wavefield survey data collected at a first time and second seismic wavefield survey data collected at a second time; and processing circuitry communicably coupled to the seismic wavefield sensor, to thereby determine time-lapsed seismic wavefield data based upon the first and second seismic wavefield survey data and analyze the time-lapsed seismic wavefield data to determine an attribute change of an earth model.

14. A system as defined in paragraph 13, wherein determining the time-lapsed seismic wavefield data comprises defining a relationship between the first and second seismic wavefield survey data.

15. A system as defined in paragraphs 13 or 14, wherein the relationship is defined using a perturbation scalar.

16. A system as defined in any of paragraphs 13-15, wherein analyzing the time-lapsed seismic wavefield data comprises performing an inversion comprising comparing the time-lapsed seismic wavefield data with simulated time-lapsed wavefield data; and minimizing an error between the time-lapsed seismic wavefield data and the simulated time-lapsed seismic wavefield data subject to constraints imposed on an earth model.

17. A system as defined in any of paragraphs 13-16, wherein analyzing the time-lapsed seismic wavefield data comprises performing an inversion comprising relating the time-lapsed seismic wavefield data to a change in compressibility; and applying a sensitivity-based analysis to determine the attribute change.

18. A system as defined in any of paragraphs 13-17, wherein analyzing the time-lapsed seismic wavefield data comprises relating the time-lapsed seismic wavefield data to a change in compressibility.

19. A system as defined in any of paragraphs 13-18, wherein analyzing the time-lapsed seismic wavefield data comprises subjecting the attribute change to one or more rock physics constraints.

20. A system as defined in any of paragraphs 13-19, wherein analyzing the time-lapsed seismic wavefield data comprises subjecting the attribute change to history-match constraints.

21. A system as defined in any of paragraphs 13-20, wherein analyzing the time-lapsed seismic wavefield data comprises applying a sensitivity-based analysis to determine the attribute change.

22. A system as defined in any of paragraphs 13-21, further comprising imaging the time-lapsed seismic wavefield data.

23. A system as defined in any of paragraphs 13-22, further comprising updating the earth model based upon the attribute change.

24. A system as defined in any of paragraphs 13-23, further comprising a downhole assembly to position at least one of the seismic wavefield source or sensor along the formation.

25. A system as defined in any of paragraphs 13-24, further comprising a downhole installation system to permanently position at least one of the seismic wavefield source or sensor along the formation.

Moreover, the methods described herein may be embodied within a system comprising processing circuitry to implement any of the methods, or a in a computer-program product comprising instructions which, when executed by at least one processor, causes the processor to perform any of the methods described herein.

Although various embodiments and methodologies have been shown and described, the disclosure is not limited to such embodiments and methodologies and will be understood to include all modifications and variations as would be apparent to one skilled in the art. Therefore, it should be understood that the disclosure is not intended to be limited to the particular forms disclosed. Rather, the intention is to cover all modifications, equivalents and alternatives falling within the spirit and scope of the disclosure as defined by the appended claims.

1. A method for monitoring a downhole formation using a time-lapsed seismic wavefield analysis, the method comprising:
emitting a seismic wavefield into a formation;
at a first time, collecting first seismic wavefield survey data of the formation in response to the emitted seismic wavefield;
at a second time, collecting second seismic wavefield survey data of the formation in response to the emitted seismic wavefield;
determining time-lapsed seismic wavefield data based upon the first and second seismic wavefield survey data; and
analyzing the time-lapsed seismic wavefield data to determine an attribute change of an earth model.

2. A method as defined in claim 1, wherein determining the time-lapsed seismic wavefield data comprises defining a relationship between the first and second seismic wavefield survey data.

3. A method as defined in claim 2, wherein the relationship is defined using a perturbation scalar.

4. A method as defined in claim 1, wherein analyzing the time-lapsed seismic wavefield data comprises performing an inversion comprising:
comparing the time-lapsed seismic wavefield data with simulated time-lapsed wavefield data; and
minimizing an error between the time-lapsed seismic wavefield data and the simulated time-lapsed seismic wavefield data subject to constraints imposed on an earth model.

5. A method as defined in claim 1, wherein analyzing the time-lapsed seismic wavefield data comprises performing an inversion comprising:
relating the time-lapsed seismic wavefield data to a change in compressibility; and
applying a sensitivity-based analysis to determine the attribute change.

6. A method as defined in claim 1, wherein analyzing the time-lapsed seismic wavefield data comprises:
relating the time-lapsed seismic wavefield data to a change in compressibility; or
subjecting the attribute change to one or more rock physics constraints.

7. (canceled)

8. A method as defined in claim 1, wherein analyzing the time-lapsed seismic wavefield data comprises:
subjecting the attribute change to a sensitivity-based analysis; or
subjecting the attribute change to history-match constraints.

9. (canceled)

10. A method as defined in claim 1, further comprising:
imaging the time-lapsed seismic wavefield data; or
updating the earth model based upon the attribute change.

11. (canceled)

12. A method as defined in claim 1, further comprising performing a downhole operation using the earth model.

13. A system for monitoring a downhole formation using time-lapse seismic wavefield analysis, the system comprising:
a seismic wavefield source;
a seismic wavefield sensor to collect seismic wavefield survey data of the formation in response to an emission from the seismic wavefield source, wherein the seismic wavefield survey data comprises first seismic wavefield survey data collected at a first time and second seismic wavefield survey data collected at a second time; and
processing circuitry communicably coupled to the seismic wavefield sensor, to thereby determine time-lapsed seismic wavefield data based upon the first and second seismic wavefield survey data and analyze the time-lapsed seismic wavefield data to determine an attribute change of an earth model.

14. A system as defined in claim 13, wherein determining the time-lapsed seismic wavefield data comprises defining a relationship between the first and second seismic wavefield survey data.

15. A system as defined in claim 14, wherein the relationship is defined using a perturbation scalar.

16. A system as defined in claim 13, wherein analyzing the time-lapsed seismic wavefield data comprises performing an inversion comprising:
comparing the time-lapsed seismic wavefield data with simulated time-lapsed wavefield data; and
minimizing an error between the time-lapsed seismic wavefield data and the simulated time-lapsed seismic wavefield data subject to constraints imposed on an earth model.

17. A system as defined in claim 13, wherein analyzing the time-lapsed seismic wavefield data comprises performing an inversion comprising:
relating the time-lapsed seismic wavefield data to a change in compressibility; and
applying a sensitivity-based analysis to determine the attribute change.

18. A system as defined in claim 13, wherein analyzing the time-lapsed seismic wavefield data comprises:
relating the time-lapsed seismic wavefield data to a change in compressibility; or
subjecting the attribute change to one or more rock physics constraints.

19. (canceled)

20. A system as defined in claim 13, wherein analyzing the time-lapsed seismic wavefield data comprises:
subjecting the attribute change to history-match constraints; or
applying a sensitivity-based analysis to determine the attribute change.

21. (canceled)

22. A system as defined in claim 13, further comprising:
imaging the time-lapsed seismic wavefield data; or
the earth model based upon the attribute change.

23. (canceled)

24. A system as defined in claim 13, further comprising a downhole assembly to position at least one of the seismic wavefield source or sensor along the formation.

25. A system as defined in claim 13, further comprising a downhole installation system to permanently position at least one of the seismic wavefield source or sensor along the formation.

26. A non-transitory computer program product comprising instructions which, when executed by at least one processor, causes the processor to perform the method of claim 1.
